(19) United States
(12) Patent Application Publication
(10) Pub. No.: US 2007/0242154 A1
(43) Pub. Date: Oct. 18, 2007

(54) System and method of controlling a feature of a portable electronic device

(75) Inventor: Jason M. Cope, Durham, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/406,101

(22) Filed: Apr. 18, 2006

(51) Int. Cl. H04N 5/222

(52) U.S. Cl. 348/370

(57) ABSTRACT

A camera-equipped portable electronic device captures an image responsive to an occurrence of a predetermined event. The captured image is processed to derive color information. This color information is then employed to control one or more multicolor lighting elements of the portable electronic device to emit a selected color of light.

### BACKGROUND

The present invention relates generally to portable electronic devices, and particularly to camera-equipped portable electronic devices that control functionality based on information derived from a captured image.

The popularity of portable electronic devices, such as camera-equipped cellular telephones and Personal Digital Assistants (PDAs), has dramatically increased. One reason for this increase is that manufacturers continue to add new features and functionality to portable electronic devices that make such devices more attractive to a wider variety of consumers. Another reason is the small size and portability of the portable electronic devices. Because compact portable electronic devices capable of performing multiple features are in higher demand than their simpler counterparts, manufacturers spend considerable resources each year exploring new ways to further enhance portable electronic devices. Those manufacturers that produce portable electronic devices having features attractive to consumers may gain a bigger market share.

### SUMMARY

The present invention is directed to a portable electronic device that is equipped with a camera. A controller in the portable electronic device controls the camera to capture an image responsive to a predetermined event. The predetermined event may be, for example, an incoming signal or message received from a wireless network, a manual command entered by a user, the expiration of a predetermined timer, or a scheduled event that occurs at the portable electronic device. An image processor associated with the portable electronic device processes raw image data of at least a portion of the captured image to derive color information. The controller uses this color information to control one or more multicolor lighting elements of the portable electronic device to emit a selected color of light.

### BRIEF DESCRIPTION OF THE DRAWINGS

FIG. 1 is a block diagram of a camera-equipped portable electronic device suitable for use according to one embodiment of the present invention.

FIG. 2A is a perspective view of a portable electronic device including features that may be controlled according to one embodiment of the present invention.

FIG. 2B is a perspective view of a rear of the portable electronic device of FIG. 2A showing a camera suitable for use according to one embodiment of the present invention.

FIG. 3 is a perspective view of an image sensor that may be used in one embodiment of the present invention.

FIG. 4 illustrates a method by which a controller configured according to one embodiment of the present invention may use information from a captured image to control a lighting feature of a portable electronic device.

FIG. 5 illustrates another method by which a controller configured according to one embodiment of the present invention may use information from a captured image to control a lighting feature of a portable electronic device.

FIG. 6 is a block diagram illustrating an exemplary light management unit that may be used to light one or more multicolor lighting elements according to one embodiment of the present invention.

### DETAILED DESCRIPTION

The present invention relates to a camera-equipped portable electronic device that controls one or more of its features based on color information derived from a captured image. In one embodiment, the portable electronic device captures an image responsive to a predetermined event. The predetermined event may be, for example, the receipt of an incoming call indication or other message from a wireless communications network, a manual command received from a user, a scheduled event, or the expiration of a predetermined time period. The portable electronic device processes at least a portion of the captured image to derive color information, and uses this color information to control the color of light emitted by multicolor lighting elements. The multicolor lighting elements alert a user of the portable electronic device to the predetermined event and may emit a color of light that substantially matches a color derived from the captured image.

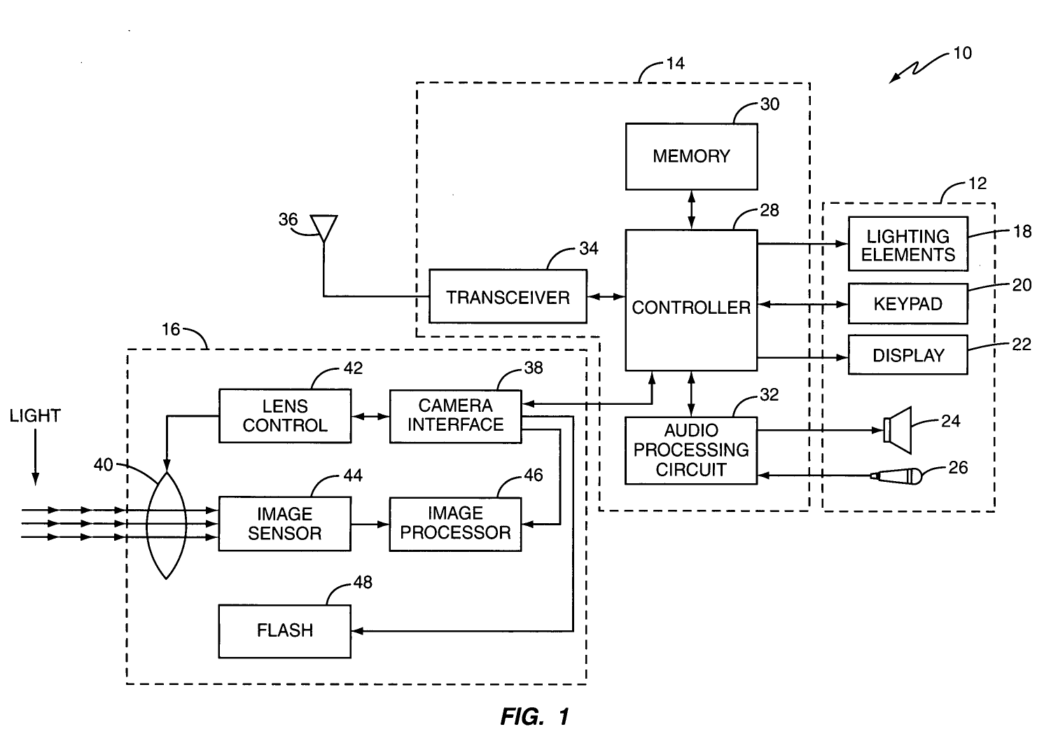

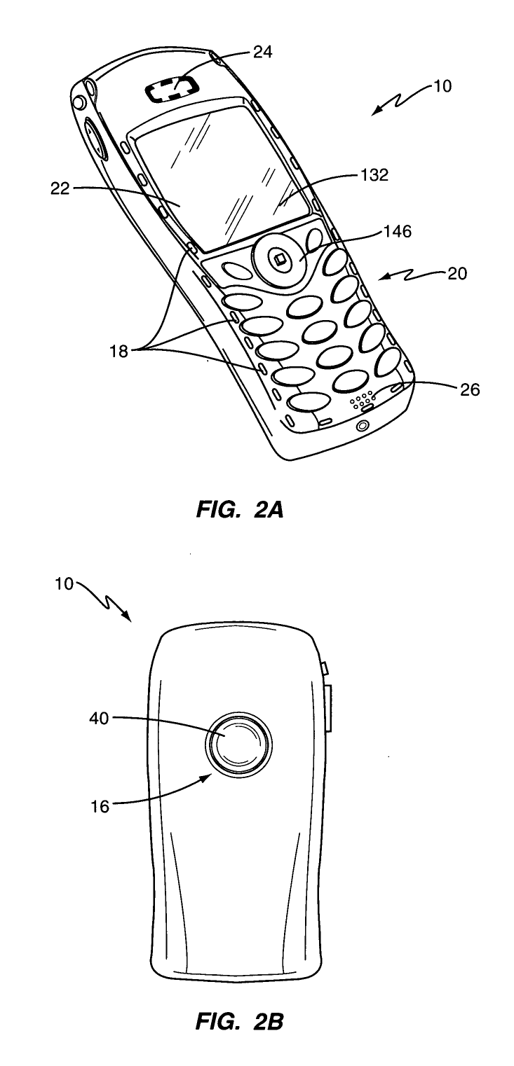

FIGS. 1 and 2 illustrate an exemplary portable electronic device according to the present invention. The illustrated portable electronic device integrates a cellular telephone and a camera into the same physical package, and is referred to herein as a camera phone 10. It should be noted, however, that the present invention is not limited to being a camera phone but may be embodied in other portable electronic devices that incorporate a camera. Such devices include, but are not limited to, personal digital assistants (PDA), personal communication service (PCS) devices, satellite phones, palm-top computers, and the like.

FIG. 1 is a block diagram showing some of the functional components of an exemplary camera phone 10. Camera phone 10 comprises a user interface (UI) 12, communications circuitry 14, and a camera 16. Generally, UI 12 allows a user to interact with and control the operation of camera phone 10. UI 12 includes one or more multicolor lighting elements 18, user controls such as a keypad 20 and display 22, a speaker 24 to render audible sound to a user, and a microphone 26 to convert the user's speech into audio signals for transmission to one or more remote parties. Keypad 20 and/or display 22 may include backlighting circuitry as is known in the art. This backlighting circuitry may be controlled to emit light of a desired color based on color information derived from captured images.

The multicolor lighting elements 18 may be set into a housing of the camera phone 10 (FIG. 2A). The multicolor lighting elements 18 may comprise, for example, tricolor Light Emitting Diodes (LEDs) capable of emitting any of a plurality of colors. As described in more detail below, a desired color may be emitted by varying a voltage and/or current supplied to the multicolor lighting elements 18 responsive to a control signal generated by the controller 28.

Communications circuitry 14 includes the components necessary to communicate data with the one or more remote parties via a wireless communications network (not shown). FIG. 1 illustrates the communications circuitry, which includes a controller 28 connected to memory 30, an audio processing circuit 32, and a transceiver 34 connected to an antenna 36. However, those skilled in the art will appreciate that camera phone 10 may include other components in addition to, or in lieu of those shown in FIG. 1 depending upon its intended use.

Controller 28 controls the operation of camera phone 10 according to programs and data stored in memory 30. The controller 28 may be implemented as a single microprocessor or multiple microprocessors. Suitable microprocessors may include, for example, both general purpose and special purpose microprocessors as well as digital signal processors. Transceiver 34 is a fully functional cellular radio transceiver coupled to an antenna 38 for receiving and transmitting signals over a wireless communications network (not shown). Those skilled in the art will appreciate that transceiver 34 may operate according to any known standard, including Global System for Mobile Communications (GSM), Universal Mobile Telecommunication System (UMTS), TIA/EIA-136, Code Division Multiple Access (CDMA), cdmaOne, cdma2000, and Wideband CDMA.

Camera 16 may be integrated within camera phone 10 (FIG. 2B), and interfaces with communication circuit 14 via a camera interface 38. Camera 16 includes lens 40, a lens control 42, an image sensor 44, an image processor 46, and an optional flash 48. Lens 40, which may comprise one or more lenses (fixed or auto-focus), manipulates an image by collecting and focusing light onto the image sensor 44 based on control signals received from lens control 42. Lens control 42 controls the optical properties of lens 40, such as focus, zoom, and shutter speed, based on control signals received from controller 28.

Image sensor 44 captures the images formed by lens 40, and may comprise any conventional image sensor, such as a charge-coupled device (CCD), a complementary metal oxide semiconductor (CMOS) image sensor, and the like. Generally, the image sensor 44 converts light focused by lens 40 into analog electrical signals for image processor 46. When CCD devices are used, additional digital-to-analog converters may be disposed between the CCD device and the image processor 46 to convert the digital signal provided by the CCD device to an analog signal usable by the image processor 46. Image processor 46 may process this raw image data for subsequent storage in memory 30, output to display 22, and/or for transmission to a remote party via communications circuit 14. In one embodiment, the image processor 46 also processes the raw image data to derive color information about the captured image.

In one embodiment, controller 28 controls the camera 16 to capture an image responsive to a predetermined event. Some types of predetermined events include, but are not limited to, the receipt of a signaling message, an incoming call, a manual command entered by the user, the expiration of a predetermined timer, or indication of a scheduled event. At least a portion of the captured image is processed to derive color information from the captured image. The controller 28 uses derived color information to generate one or more control signals to cause the multicolor lighting elements 18 to emit a desired color of light. The controller 28 may receive the derived color information from an image processor 46 that processes the portion of the captured image, or include image processing capabilities to derive the color information from the portion of the captured image.

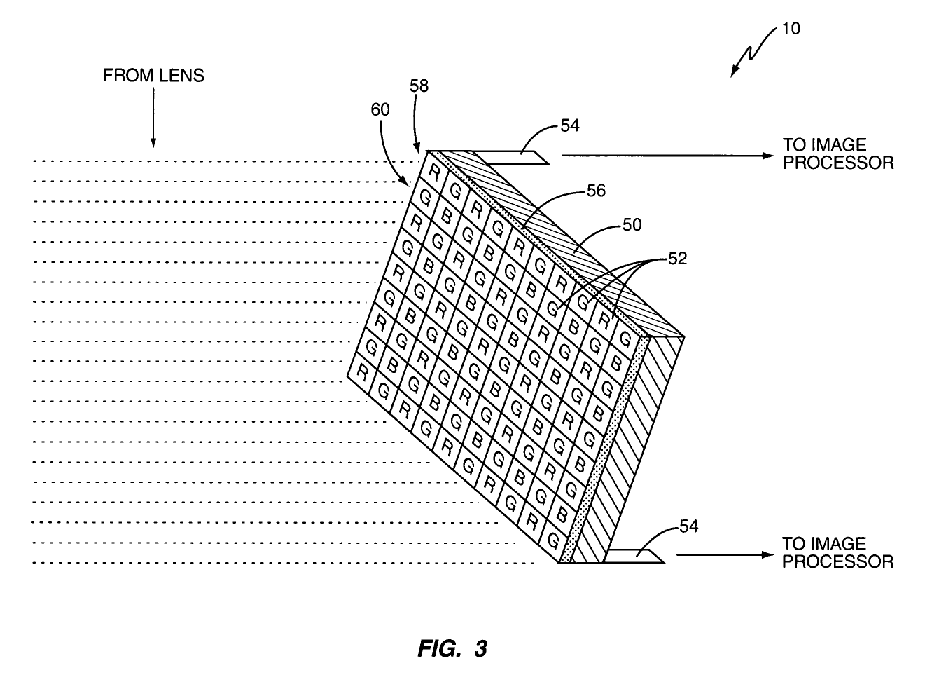

FIG. 3 illustrates how one embodiment of the present invention may determine color information from a portion of a captured image. As seen in FIG. 3, the light sensor 44 may comprise a CMOS device 50. CMOS device 50 comprises a two-dimensional array of photovoltaic cells or modules 52 constructed from a semiconductor material such as silicon. Each photovoltaic cell 52 translates to a pixel in an image. The number of photovoltaic cells 52 in the array determines the resolution of an image. Thus, the greater the number of photovoltaic cells 52, the higher the resolution and the sharper the image. Each photovoltaic cell 52 generates an electrical current in response to detecting light (i.e., photons) that strike the surface of the CMOS device 50. The image processor 46 connects to the CMOS device 50 via conductive strips 54 and uses the generated currents to produce pixels of raw image data.

By itself, CMOS device 50 is a grayscale device that only detects the total intensity of the light that strikes the photovoltaic cells 52. To get color information, CMOS device 50 employs filtering to obtain information about the three primary colors of the light (i.e., red, green, blue) striking CMOS device 50. While there are many known methods of filtering, one embodiment of the present invention uses a color filter array such as a Bayer filter 56, for example.

As seen in FIG. 3, the Bayer filter 56 comprises a checkerboard pattern of red (R), green (G), and blue (B) filters placed over the surface of CMOS device 50. This pattern alternates rows of green and red filters 58 with rows of blue and green filters 60, although other patterns may be employed. Each photovoltaic cell 52 is associated with a specific primary color R, G, or B, and thus, will generate a current indicative of different intensities of red, green, or blue light. The image processor 46 represents this generated current as a pixel in the raw image data.

To obtain the color information, the image processor 46 interpolates the raw image data. In one embodiment, the image processor 46 employs a demosaicing algorithm to obtain the color information. Demosaicing algorithms determine a true color value for each primary color in a given pixel by calculating an average value from each of its closest surrounding pixels. This yields a mosaic of true color values for each primary color R, G, and B in each pixel, which together closely represents the true color of the portion of the captured image being processed. From these true color values, the image processor 46 may calculate an average value for each primary color R, G, B at each pixel in the mosaic.

In one embodiment, each pixel in the mosaic has a true color value between 0 and 255 for each primary color R, G, and B. The image processor 46 may add all the red true color values in the mosaic to obtain a summed value for R. Likewise, the image processor 46 may add all the green and blue true color values in the mosaic to obtain summed values G and B, respectively. The image processor 46 then divides each summed value by the number of pixels in the mosaic to produce three averaged values between 0 and 255—one averaged value for R, one averaged value for G, and one averaged value for B. These three averaged values are sent to the controller 28, which uses them to control the color of light emitted by the multicolor lighting elements 18.

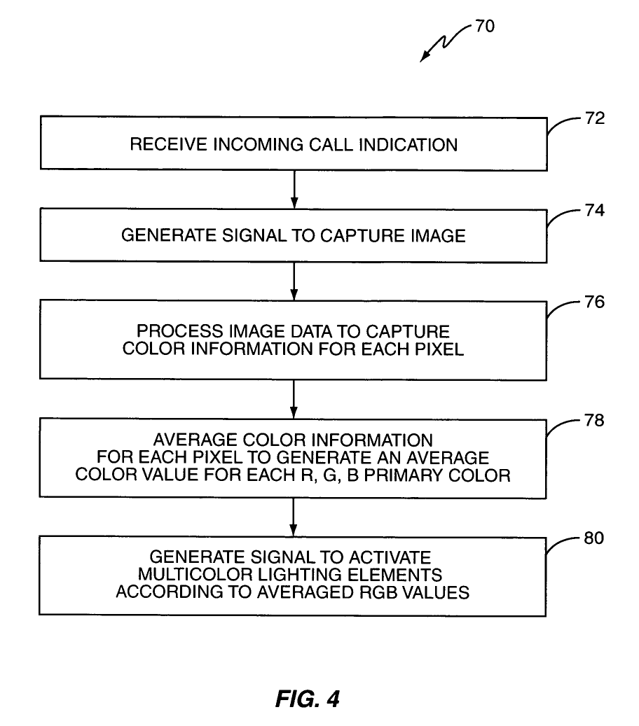

FIG. 4, for example, illustrates one automated method 70 of alerting a user to an incoming call by controlling the multicolor lighting elements 18 to emit a color of light that substantially matches a color derived from at least a portion of a captured image. In method 70, the controller 28 receives an indication of a predetermined event such as an incoming call from the wireless network (box 72). In response, controller 28 generates a control signal to cause the camera 16 to capture an image (box 74). The image processor 46 processes the raw image data to produce true color values for each primary color R, G, and B as described above (box 76), and averages the true color values to derive an average color value for each primary color R, G, and B (box 78). Each average color value is then sent to the controller 28, which uses them to generate control signals that causes the multicolor lighting elements 18 to emit a certain color of light (box 80).

By way of example, if a processed portion of a captured image is red or substantially red, the average values sent from image processor 46 will indicate red as being the primary color. The controller 28 will therefore generate control signals to cause the multicolor lighting elements 18 to emit a red light. Likewise, if the average values sent from image processor 46 indicates that the processed portion of the captured image is orange or blue (or substantially so), the controller 28 will generate control signals to cause the multicolor lighting elements 18 to emit an orange or blue light, respectively.

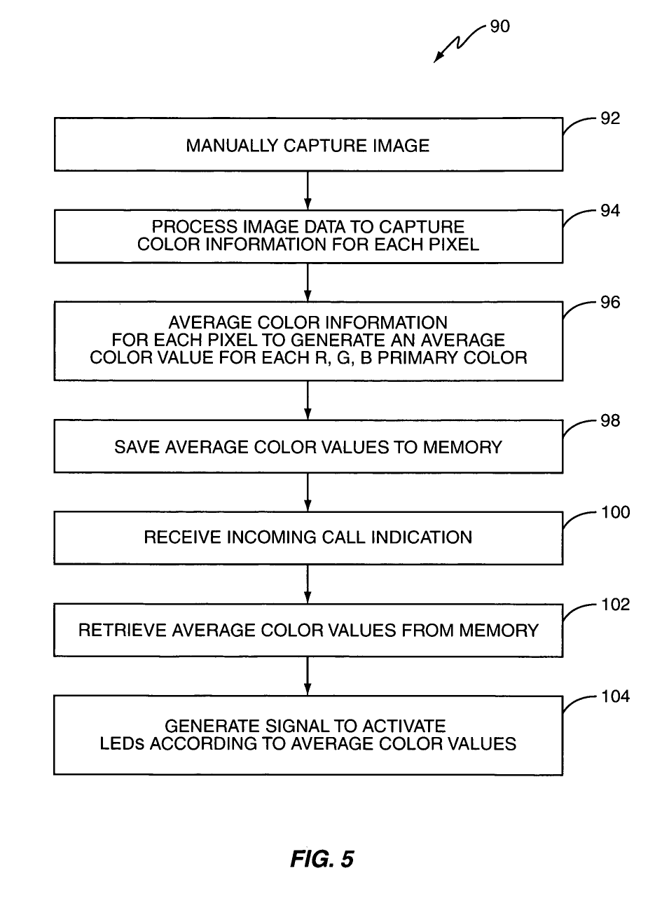

FIG. 5 illustrates another method 90 of controlling the multicolor lighting elements 18 to emit a color of light based on the color information derived from a portion of a captured image. As seen in FIG. 5, the user may manually capture an image using the controls on keypad 22. The image processor 46 processes the raw image data representing at least a portion of the captured image to determine the true color values for each pixel (box 94). The image processor then calculates an average color value for R, G, and B as previously described (box 96). The controller 28 then saves these average values to memory 30 (box 98). Upon receipt of an incoming call or other predetermined event (box 100), controller 28 retrieves the average values from memory (box 102) and based on these values, generates one or more control signals to control the multicolor lighting elements 18 to emit a color of light commensurate with the average values (box 104).

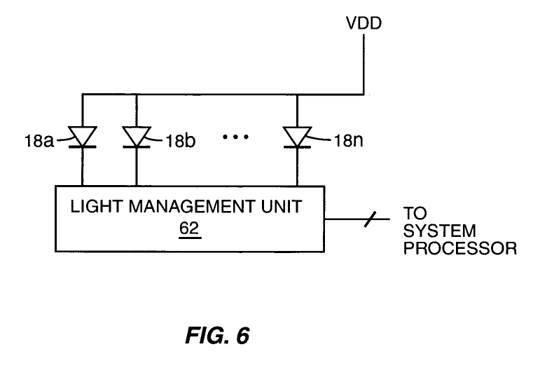

FIG. 6 illustrates one exemplary control arrangement for controlling multicolor lighting elements 18 using the control signal(s) generated by controller 28. In FIG. 6, the multicolor lighting elements 18 comprise tricolor LEDs 18a-18n that interface to controller 28 through a light management unit 62. The light management unit 62 may comprise, for example, simple transistor-based drive circuits that allow for direct control of individual ones of the multicolor lighting elements 18a-18n by the controller 28. In one embodiment, the controller 28 has bit I/O lines that can be dedicated to lighting control to provide simple on/off control, or more sophisticated modulation/pulsing control, and color selection. Alternatively, the light management unit 62 may comprise one or more LED control circuits providing discrete control lines, or a serial or parallel interface (bused or non-bused), through which the controller 28 effects desired lighting control.

In one embodiment, the light management unit 62 supplies the LEDs 18a-18n with drive signals at predetermined voltages and/or current levels based on the control signals received from controller 28. In other embodiments, the light management unit 62 controls the direction of a current applied to the LEDs 18a-18n based on the control signals sent from the controller 28. In either case, the LEDs 18a-18n emit light of a specified color depending upon the voltages and/or current values, and/or the direction of the current.

The embodiments above describe the controller 28 as using color information derived from a captured image or a portion of a captured image to cause multicolor lighting elements 18 to emit a color of light commensurate with the derived color. Additionally, however, the controller 28 may also generate one or more control signals to control the backlighting of keypad 20 and/or display 22 in a similar manner. In these embodiments, keypad 20 and/or display 22 may comprise an array of multicolor lighting elements capable of emitting various colors of light at various intensities.

Further, the present invention is not limited to responding solely to the receipt of an incoming call. Rather, the controller 28 may generate control signals to capture an image and control various multicolor lighting elements in response to other predetermined events including, but not limited to, scheduled events, incoming pages or other signaling messages, SMS messages, e-mail messages, and the like.

In addition, the present invention is not limited to simply controlling various multicolor lighting elements to emit a specific color. In one embodiment, for example, the image processor 46 uses a similar approach to calculate a value indicative of an average intensity for the pixels in the raw image data. The image processor 46 sends this average intensity value to controller 28 along with the three R, G, B average color values. Based on the average color values and the average intensity value, the controller 28 may generate one or more control signals to control the color of light emitted by the various multicolor lighting elements 18 as well as the intensity.

As those skilled in the art will appreciate, the controller 28 is capable of generating control signals(s) to cause the multicolor lighting elements 18 to emit any color(s) at any intensity, and is limited only by the capabilities of the particular lighting elements. Some multicolor lighting elements 18 presently have the capability to emit colors that include, but are not limited to, various levels of red (e.g., Ultra Red, High Efficiency Red, Super Red, etc.), as well as like levels for other colors such as orange, yellow, green, white, purple, pink, and blue. However, ongoing research into the physical characteristics of multicolor lighting elements may produce multicolor lighting elements 18 that will be capable of emitting other colors at other intensities not specifically listed above. Those skilled in the art will readily appreciate that the controller 28 may also employ such multicolor lighting elements and cause them to emit the color(s) at intensities they are capable of emitting based on color and/or intensity information derived from a captured image or a selected portion of a captured image.

Further, the foregoing described embodiments of the present invention in terms of image processor 46 being a component that is separate from controller 28. However, this distinction between these components is for clarity only. In some embodiments, controller 28 may include all or some of the image processing circuitry of image processor 46, and thus, controller 28 may perform all or some of the functionality performed by image processor 46.

It should also be noted that some camera phones 10 may include the processing power to perform object recognition. In such camera phones 10, the image processor 46 and/or the controller 28 may be configured to select and recognize a particular object in the captured image. Once recognized, the image processor 46 and/or the controller 28 may select and process the portion of the captured image that includes the object to derive color information about the object. Multicolor lighting elements 18 and/or backlighting circuitry may then be controlled to emit a color of light at an intensity commensurate with the object's derived color and intensity information.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A portable electronic device comprising:
a camera to capture an image of an object having a color responsive to a predetermined event;
a lighting element; and
a controller communicatively connected to the camera and the lighting element and configured to generate a control signal to cause the lighting element to emit a selected color of light based on color information derived from the captured image.

2. The device of claim 1 further comprising an image processor configured to process a portion of the captured image to derive a plurality of average color values, each average color value being indicative of a different primary color in the captured image.

3. The device of claim 2 wherein the controller is configured to generate the control signal to control the lighting element to emit the selected color of light based on the derived average color values.

4. The device of claim 2 wherein the image processor is further configured to derive an average intensity value indicative of the intensity of the average color values.

5. The device of claim 4 wherein the controller is configured to generate the control signal to control an intensity of the lighting element based on the average intensity value.

6. The device of claim 1 further comprising a light management unit to receive the control signal from the controller and to control the lighting element to emit the selected color of light based on the control signal.

7. The device of claim 1 wherein the selected color of light represents the color of an object in the captured image.

8. The device of claim 7 wherein the lighting element comprises one or more multicolor Light Emitting Diodes (LEDs) connected to a housing of the portable electronic device.

9. The device of claim 7 wherein the lighting element comprises an array of multicolor lighting elements used in a display of the portable electronic device.

10. The device of claim 7 wherein the lighting element comprises one or more multicolor lighting elements associated with a user interface of the portable electronic device.

11. The device of claim 1 wherein the portable electronics device further comprises a transceiver to communicate with a wireless communications network, and wherein the controller is configured to control the camera to capture the image responsive to an indication received from the network.

12. The device of claim 1 further comprising an image sensor to detect light representing the object being captured by the camera.

13. The device of claim 12 wherein the image sensor comprises a complementary metal oxide semiconductor (CMOS) device.

14. The device of claim 12 wherein the image sensor comprises a charge-coupled device (CCD).

15. The device of claim 1 further comprising memory to store the color information derived from the captured image.

16. The device of claim 15 wherein the controller is further configured to retrieve the derived color information from memory responsive to the predetermined event, and generate the control signal to cause the lighting element to emit the selected color of light based on the retrieved color information.

17. A method of controlling a feature of a portable electronic device, the method comprising:
capturing an image of an object having a color responsive to a predetermined event;
processing the captured image to derive color information; and
controlling a multicolor lighting element of the portable electronic device to emit a selected color of light based on the derived color information.

18. The method of claim 17 wherein capturing an image of an object having a color responsive to a predetermined event comprises controlling a camera of the portable electronic device to capture the image responsive to detecting the predetermined event.

19. The method of claim 18 wherein the predetermined event comprises a received signal received from a wireless communications network.

20. The method of claim 18 wherein the predetermined event comprises a command manually entered by a user at a user interface of the portable electronic device.

21. The method of claim 17 wherein processing the captured image to derive color information comprises processing raw image data of at least a portion of the captured image to calculate an average color value for each of a red, green, and blue primary color.

22. The method of claim 21 wherein the raw image data being processed comprises one or more pixels, and wherein generating an average color value for each of a red, green, and blue primary color comprises:
summing a first value indicative of the red primary color in each pixel being processed to calculate a first summed value;
summing a second value representing the green primary color in each pixel being processed to calculate a second summed value;
summing a third value representing the blue primary color in each pixel being processed to calculate a third summed value; and
dividing each of the first, second, and third summed values by the number of pixels that were processed to generate the average color values.

23. The method of claim 21 wherein controlling the multicolor lighting element to emit a selected color of light comprises generating a control signal based on the average color values.

24. The method of claim 22 further comprising processing the captured image to derive an average intensity value for the average color values, and controlling the multicolor lighting element to emit the selected color of light at an intensity based on the average intensity value.

25. The method of claim 17 further comprising retrieving the color information from memory responsive to detecting the predetermined event, and generating the control signal to control the multicolor lighting element based on the retrieved color information.

26. The method of claim 17 wherein the selected color of light emitted by the multicolor lighting element represents the color of an object in the captured image.

27. The method of claim 17 wherein controlling a multicolor lighting element comprises controlling one or more multicolor Light Emitting Diodes (LEDs) connected to a housing of the portable electronic device to emit the selected color of light.

28. The method of claim 17 wherein controlling a multicolor lighting element comprises controlling an array of multicolor lighting elements used in a display of the portable electronic device to emit the selected color of light.

29. The method of claim 17 wherein controlling a multicolor lighting element comprises controlling an array of multicolor lighting elements used in a user interface of the portable electronic device to emit the selected color of light.
